(19) United States
(12) Patent Application Publication
(10) Pub. No.: US 2024/0430258 A1
(43) Pub. Date: Dec. 26, 2024

(54) METHOD FOR INCREASING CONFIDENCE IN VERIFICATION OF IDENTITY OF A PERSON

(71) Applicant: UAB "iDenfy", Kaunas (LT)

(72) Inventor: Domantas CIULDE, Kaunas (LT)

(21) Appl. No.: 18/337,500

(22) Filed: Jun. 20, 2023

(51) Int. Cl. H04L 9/40

(52) U.S. Cl. CPC H04L 63/0869

(57) ABSTRACT

The invention is a method for increasing confidence in verification in digital environment of identity of a first person being associated with a person to be verified for authorisation purposes by a second person on request of a third person. The method comprises registering a first person in database of the second person where verification of the first person is initiated by the second person. After the verification is initiated a digital code, such as QR, 6-digits, 8-digits or similar digital code in a non-digital form is mailed in a physical letter to a verifiable address linked with the first person. After the code is scanned by the first person identity verification in digital environment by the third person is initiated.

### TECHNICAL FIELD

The invention relates to method for verification of identity of a person and in particular to a method for increasing confidence in verification of identity of a person having a residential address.

### BACKGROUND ART

An address is a vital identification attribute to verify a person's identity. Proof of Address is often requested when opening a bank account or other government account to confirm residence, help Know Your Customer (KYC) compliance and prevent fraudulent activities.

Address verification is a process of proving that an address which a customer, user or applicant gives to a person of interest, such as service provider, exists and that the person can be linked to that address by checking against data sources such as credit reference records. Not everyone can be visited to make sure address is matching a resident. Such verification is usually done by asking for a copy of a document such as a driving license, bank statement or utility bill and entering the address into validation service.

Proof of Address also ensures services are only available to customers within a specific geographical area. Beyond compliance, address verification also helps reduce fraudulent or unwanted activities online.

Proof of Address is evidence that a person has an actual physical address that matches their stated address. The real address needs to exist, and there must be supporting evidence that the person currently resides there. Billing statements from legitimate organizations that go to the same address help prove the person lives there.

Combining identity document checks with address verification checks allows validating an identity document to assess that it's genuine and verifying that the details given by a holder match their residential address. It increases confidence in identity of a person.

Nevertheless, billing statements and alike from legitimate organizations that go to an address of a resident having residents name om it may be easily faked. A scanned copy may have an altered name of a resident or other details proving address of a person.

Conventional identity verification systems require users to provide identity information electronically by submitting identity information to an authentication mechanism via user interface(s). In many cases, users must enter their identity information into a web form, or scan or otherwise capture biometric data using a camera or other like device. Additionally, many service providers require their users to enter/scan and submit user identifying information for those users to access their platforms. Identity verification process may utilize identity information from physical identifying documents, images or videos of physical identifying documents, authentication or authorization credentials, identity scores, biometric data, and/or knowledge-based authentication (KBA) data to authenticate a user's identity.

US patent No.: U.S. Pat. No. 8,365,258B2 discloses multifactor authentication system, where in one embodiment, a network element comprises one or more processors, and a memory module communicatively coupled to the processor. The memory module comprises logic instructions which, when executed by the processor, configure the processor to receive, via a first communication channel, a primary authentication request transmitted from a user from a first device, process the primary authentication request to determine whether the user is authorized to access one or more resources, in response to a determination that the user is authorized to access one or more resources, initiate, a secondary authentication request, and transmit the secondary authentication request from the network element to the user via a second communication channel, different from the first communication channel. Main disadvantage of the disclosed object is that all authentication steps are in digital environment.

The present invention is dedicated to overcoming of the above shortcomings and for producing further advantages over prior art.

### BRIEF DESCRIPTION OF THE INVENTION

The invention is a method for increasing confidence in verification in digital environment of identity of a person comprising verifying personal data of a first person being associated with a person to be verified for authorisation purposes by a second person on request of a third person. The method comprises registering a first person, a person to be verified and authorised, in database of the second person, a person requesting verification of the first person for authorization purposes. Afterwards verification of the first person is initiated by the second person. The request for verification comprises digital data such as: name and surname of the first person; a verifiable address of the first person comprising street name, house number, apartment number, etc.; biometric data of the first person; copy of ID or similar document of the first person. After the verification is initiated a digital code, such as QR, 6-digits, 8-digits or similar digital code in a non-digital form is mailed in a physical letter. The first person receives the letter, scans the code and initiates identity verification in digital environment by the third person. The first person identity is thus confirmed or rejected by the third person. The second person is likewise informed of the verification outcome.

This process ensure that the first person is verified as a person which should be authenticated by the second person and have access or is registered to a verifiable address. Processing of a code mailed in a physical letter to a verifiable physical address of residence or alike increases confidence in verification of identity of a person.

### DETAILED DESCRIPTION OF THE INVENTION

It should be understood that numerous specific details are presented in order to provide a complete and comprehensible description of the invention embodiment. However, the person skilled in art will understand that the embodiment examples do not limit the application of the invention which can be implemented without these specific instructions. Well-known methods, procedures and components have not been described in detail for the embodiment to avoid misleading. Furthermore, this description should not be considered to be constraining the invention to given embodiment examples but only as one of possible implementations of the invention.

The method for increasing confidence in verification of identity of a person comprises steps:
registering a first person, who is a person to be verified and authorised, in a database of the second person, who is a person requesting verification of the first person for authorization purposes. The registration may comprise creating a digital identity profile that describes the first person's personal data.
initiating a verification of the first person by the second person. Verification is initiated by a merchant or other body. The verification is initiated by sending a request to verify identity via a global system of interconnected computer networks that uses the Internet protocol suite (TCP/IP) to communicate between networks and devices. The request is sent from first computer device, such as a laptop or desktop computer, a handheld device such as tablet computer or smartphone, of the second person requesting verification to a second computer device such as a laptop or desktop computer, a handheld device such as tablet computer or smartphone, of a third person verifying identity of the first person. The request may be sent using any known digital communication means, such as email, request registering software application, etc. The request for verification comprises digital data such as: name and surname of the first person; a verifiable address of the first person, comprising street name, house number, apartment number, etc.; biometric data of the first person; copy of ID or similar document of the first person being received by the third person via global system of interconnected computer networks.
generating a digital code, such as QR, 6-digits, 8-digits or similar digital code to refer to the first person as registered in database of the third person as provided by the second person or to direct the first person to a specific web page of global system of interconnected computer networks when scanned with an image capturing device connected to a computer device linked to the global system of interconnected computer networks.
converting the generated digital code, such as QR, 6-digits, 8-digits or similar digital code to a non-digital form by printing it on a sheet of paper or other similar media.
mailing the printed digital code to a verifiable address to which the first person is linked or registered. Mailing is in a sense of sending a physical letter using delivery services, such as DHL, UPS, Postal service, etc.,
scanning or otherwise digitalizing the printed digital code by the first-person, for example in a software application environment having a graphical user interface in a computer device such as a laptop or desktop computer, a handheld device such as tablet computer or smartphone, and sending via a global system of interconnected computer networks that uses the Internet protocol suite (TCP/IP) the scanned code to the third person for the scanned code validation.
initiating identity verification in digital environment by the third person. Further to the digital code, ID document such as national ID card, face of the first-person is digitized by image capturing device to complement the assigned digital code, such as QR, 6-digits, 8-digits or similar digital code assigned to the first-person being assigned or registered to the verifiable address to which the physical letter was sent.
sending digital confirmation, rejection or other information by the third person to the first person via environment with a graphical user interface.
sending digital confirmation, rejection or other information by the third person to the second person via environment with a graphical user interface. This process ensure that the first person is verified as a person which should be authenticated by the second person and have access or is registered to a verifiable address.

Although numerous characteristics and advantages together with structural details and features have been listed in the present description of the invention, the description is provided as an example fulfilment of the invention. Without departing from the principles of the invention, there may be changes in the details, especially in the form, size and layout, in accordance with most widely understood meanings of the concepts and definitions used in claims.

1. A method for increasing confidence in verification in digital environment of identity of a person, comprising verifying personal data of a first person being associated with a person to be verified for authorisation purposes by a second person
wherein the method comprises steps:
registering a first person, a person to be verified and authorised, in database of the second person, a person requesting verification of the first person for authorization purposes,
initiating a verification of the first person by the second person, where the verification is initiated by sending from a first computer device of the second person a request to verify identity of the first person via a global system of interconnected computer networks that uses the Internet protocol suite (TCP/IP) to communicate between networks and devices to a second computer device of the third person verifying identity of the first person, where the request for verification comprises digital data such as: name and surname of the first person;
a verifiable address of the first person comprising street name, house number, apartment number, etc.; biometric data of the first person; copy of ID or similar document of the first person,
generating a digital code, such as QR, 6-digits, 8-digits or similar digital code to refer to the first person as registered in the database of the third person as provided by the second person or to direct the first person to a specific web page of global system of interconnected computer networks when scanned with an image capturing device connected to a computer device linked to the global system of interconnected computer networks,
converting the generated digital code, such as QR, 6-digits, 8-digits or similar digital code to a non-digital form by printing it on a sheet of paper or similar media,
mailing a physical letter comprising the printed digital code to a verifiable address to which the first person is linked or registered,
scanning or otherwise digitalizing the printed digital code by the first-person and sending the digitalised printed digital code to the third person via computer communication means,
initiating identity verification in digital environment by the third person,
sending digital confirmation, rejection or other information by the third person to the first person via environment with a graphical user interface, and
sending digital confirmation, rejection or other information by the third person to the second person via environment with a graphical user interface.
